(19) United States
(12) Patent Application Publication
(10) Pub. No.: US 2021/0118293 A1
(43) Pub. Date: Apr. 22, 2021

(54) METHOD FOR CONTROLLING A VEHICLE IN AN AUTONOUMOUS DRVING SYSTEM

(71) Applicant: LG ELECTRONICS INC., Seoul (KR)

(72) Inventor: Nayoung YI, Seoul (KR)

(73) Assignee: LG ELECTRONICS INC., Seoul (KR)

(21) Appl. No.: 16/702,436

(22) Filed: Dec. 3, 2019

(30) Foreign Application Priority Data
Oct. 21, 2019 (KR) 10-2019-0130554

(51) Int. Cl. G08G 1/0967; G08G 1/01; G08G 1/00; G05D 1/00

(52) U.S. Cl. CPC G08G 1/096725; G08G 1/012; G08G 1/22; G05D 2201/0213; G05D 1/0088; G08G 1/0133; G08G 1/096791

(57) ABSTRACT

A method for controlling a vehicle in an autonomous driving system according to an embodiment of the present disclosure includes monitoring driving information, acquiring a position information from the driving information, and forming a cluster such that at least some areas of a plurality of vehicles share one lane, based on confirmation that the position information corresponds to the alignment section. One or more of an autonomous vehicle, a user terminal, and a server of the present invention may be associated with an artificial intelligence module, a drone ((Unmanned Aerial Vehicle, UAV), a robot, an AR (Augmented Reality) device, a VR (Virtual Reality) device, a device associated with 5G services, etc.

### CROSS-REFERENCE TO RELATED APPLICATIONS

Pursuant to 35 U.S.C. § 119(a), this application claims the benefit of earlier filing date and right of priority to Korean Patent Application No. 10-2019-0130554, filed on Oct. 21, 2019, the contents of which are hereby incorporated by reference herein in its entirety.

### BACKGROUND OF THE INVENTION

### Field of the Invention

The present disclosure relates to a method for controlling a vehicle in an autonomous driving system.

### Related Art

Vehicles, in accordance with the prime mover that is used, can be classified into an internal combustion engine vehicle, an external combustion engine vehicle, a gas turbine vehicle, an electric vehicle or the like.

An autonomous vehicle refers to a vehicle that can drive by itself without operation by a driver or a passenger, and an automated vehicle & highway system refers to a system that monitors and controls such an autonomous vehicle to be able to drive by itself.

The autonomous vehicle can respond to external driving environment more quickly than people. Therefore, there are proposed methods for more efficiently coping with traffic environment by controlling autonomous driving in various ways.

### SUMMARY OF THE INVENTION

The present disclosure is intended to solve the above-described necessities and/or problems.

The present disclosure provides a method for controlling a vehicle in an autonomous driving system, capable of reducing the overall traffic volume of a road by using the road more efficiently in a traffic congestion section.

The technical objects which are to be achieved by the present disclosure are not limited to the above-mentioned technical objects, and other technical objects which are not mentioned above will be clearly understood by those skilled in the art from the following detailed description of the present disclosure.

In an aspect, a method for controlling a vehicle in an autonomous driving system is provided. The method may include monitoring driving information, confirming whether position information acquired from the driving information corresponds to an alignment section where a traffic jam occurs, and forming a cluster such that at least some areas of a plurality of vehicles share one lane, when it is confirmed that the position information corresponds to the alignment section.

The confirming whether the position information corresponds to the alignment section may include causing a server to acquire traffic information, causing the server to learn the traffic information and determine the alignment section, and transmitting information on the alignment section to vehicles that are scheduled to enter the alignment section.

The forming of the cluster may include setting a positional relationship between the vehicles such that (n+m) vehicles (n and m are natural numbers) are arranged side by side in a direction perpendicular to a travel direction over n lanes.

The forming of the cluster may include receiving a cluster request signal from a leader vehicle, when it is confirmed that the vehicle enters the alignment section, and causing the vehicle to join in the cluster, in response to the cluster request signal.

The forming of the cluster may further include retrieving a lane change route, in response to the cluster request signal, and transmitting an acknowledgement signal for acknowledging that the vehicle may join in the cluster to the leader vehicle, when it is confirmed that there is no error situation for entering the lane change route.

The transmitting of the acknowledgement signal may be performed when it is confirmed that a size of a host vehicle is less than a reference size, and the reference size may be set to be less than ⅔ of a lane width.

The transmitting of the acknowledgement signal may be performed when it is confirmed that the vehicle is driving in the same direction as the leader vehicle at an intersection located within a predetermined distance.

The forming of the cluster may further include receiving a vehicle-information transmission request from the leader vehicle that has received the response signal, and transmitting the vehicle information including information on the size of the host vehicle to the leader vehicle, in response to the vehicle-information transmission request.

The forming of the cluster may further include determining a position of a member vehicle in the cluster to which the leader vehicle transmits the acknowledgement signal, based on the vehicle information.

The determining of the position of the member vehicle may arrange two vehicles side by side in a direction perpendicular to a driving direction in one lane, based on the size information.

The determining of the position of the member vehicle may arrange three vehicles side by side in a direction perpendicular to a driving direction in two lanes, based on the size information.

The vehicle information may further include information on a travelling route, and the determining of the position of the member vehicle may be performed based on the information on the travelling route, and the member vehicle may be disposed in a direction away from a row of the cluster.

The determining of the position of the member vehicle may further include disposing the member vehicle travelling the longest section with the leader vehicle in the same row as the leader vehicle, when the cluster is formed of two or more rows.

The method may include broadcasting the cluster request signal such that the host vehicle serves as the leader vehicle, when it is confirmed that the cluster request signal is not received for a reference time.

The forming of the cluster may further include identifying a vehicle that transmits the acknowledgement signal informing that the vehicle is to join in the cluster, in response to the cluster request signal, requesting the vehicle information including information on the vehicle size from the member vehicle transmitting the acknowledgement signal, in response to the acknowledgement signal, and determining positions of member vehicles in the cluster, based on the vehicle information.

The method may further include driving while maintaining the cluster, detecting an obstacle by at least one vehicle in the cluster, confirming whether there is a lane to avoid the obstacle while maintaining the cluster, and avoiding the obstacle while maintaining the cluster.

The method may further include temporarily releasing the cluster to avoid the obstacle, when it is confirmed that there is no lane to avoid the obstacle while maintaining the cluster.

The forming of the cluster may further include dividing the vehicles constituting the cluster into the leader vehicle and the member vehicle, causing the leader vehicle to receive a message from a vehicle other than the cluster, causing the leader vehicle to transmit the message to the member vehicle, and causing the member vehicle to change driving based on the message.

Further, according to an embodiment of the present disclosure, it is possible to reduce a traffic volume on a road by forming a cluster such that a plurality of vehicles shares one lane depending on traffic volume and road conditions.

The effects of the present disclosure are not limited to the effects described above and other effects can be clearly understood by those skilled in the art from the following description.

### BRIEF DESCRIPTION OF THE DRAWINGS

The accompanying drawings, which are included as part of the detailed description to help understand the present disclosure, provide an embodiment of the present disclosure and together with the description, describe the technical features of the present disclosure.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram referred to in description of a usage scenario of a user according to an embodiment of the present invention.

FIG. 10 shows an example of a type of V2X application.

FIG. 11 is a diagram showing an autonomous driving system according to an embodiment of the present disclosure.

FIG. 12 is a flowchart showing a method for controlling a vehicle in an autonomous driving system according to an embodiment of the present disclosure.

FIG. 13 is a diagram showing an example of a micro car.

FIG. 14 includes diagrams showing an example of a cluster.

FIG. 15 is a diagram showing an embodiment of a method for determining an alignment section.

FIG. 16 is a flowchart illustrating an embodiment of a cluster forming process.

FIG. 17 is a flowchart showing a cluster joining process according to an embodiment of the present disclosure.

FIG. 18 is a flowchart illustrating a cluster forming process according to another embodiment.

FIG. 19 is a flowchart showing a method for controlling a vehicle in an autonomous driving system according to an embodiment of the present disclosure.

FIG. 20 includes diagrams illustrating a cluster forming process in a single lane.

FIG. 21 includes diagrams illustrating a cluster forming process in a plurality of lanes.

FIG. 22 includes diagrams illustrating embodiments of a communication method in cluster driving.

FIG. 23 is a flowchart illustrating a deviation process of a member vehicle in the cluster driving.

FIG. 24 is a flowchart illustrating a process where a member vehicle deviates from a cluster according to another embodiment.

FIG. 25 includes diagrams illustrating temporary release of a cluster formation to avoid an obstacle.

Accompanying drawings included as a part of the detailed description for helping understand the present disclosure provide embodiments of the present disclosure and are provided to describe technical features of the present disclosure with the detailed description.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5th generation mobile communication required by autonomous driving systems and autonomous vehicles will be described in paragraphs A through G.

A. Example of Block Diagram of UE and 5G Network

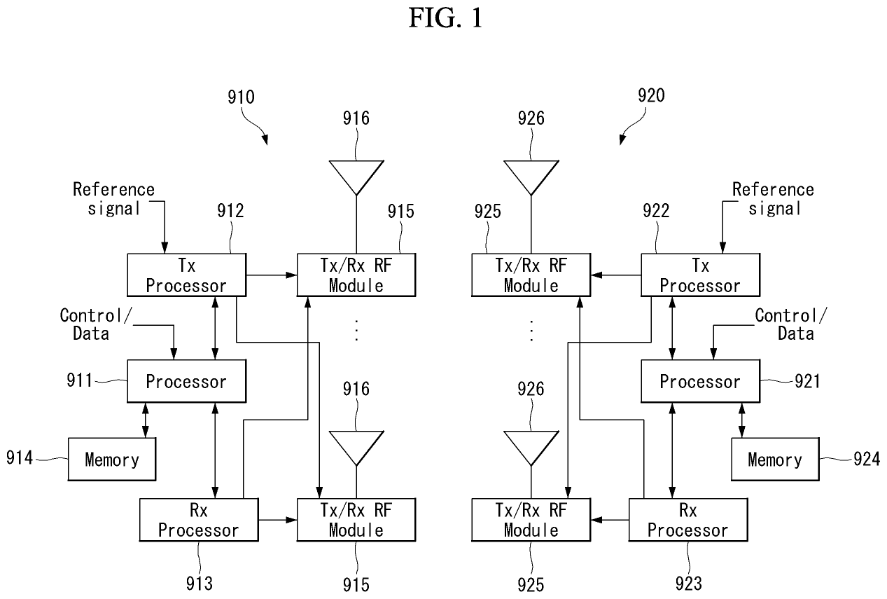

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

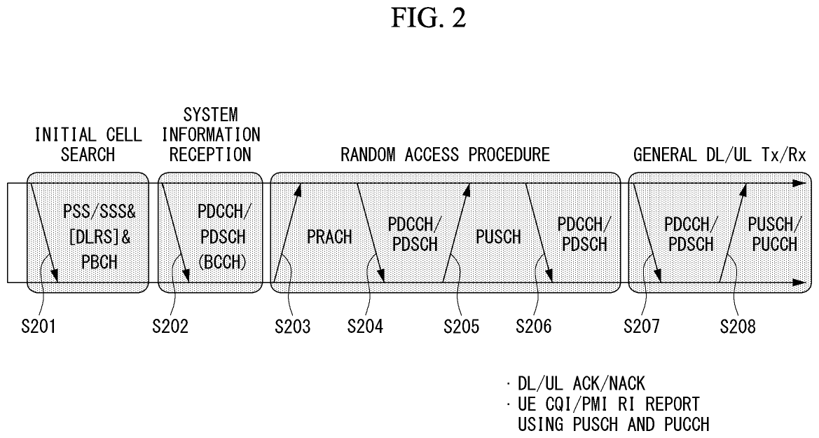

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to confirm a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of 15 ms, 10 ms, 20 ms, 40 ms, 80 ms, 160 ms by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlockl) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE confirms whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCelllD, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

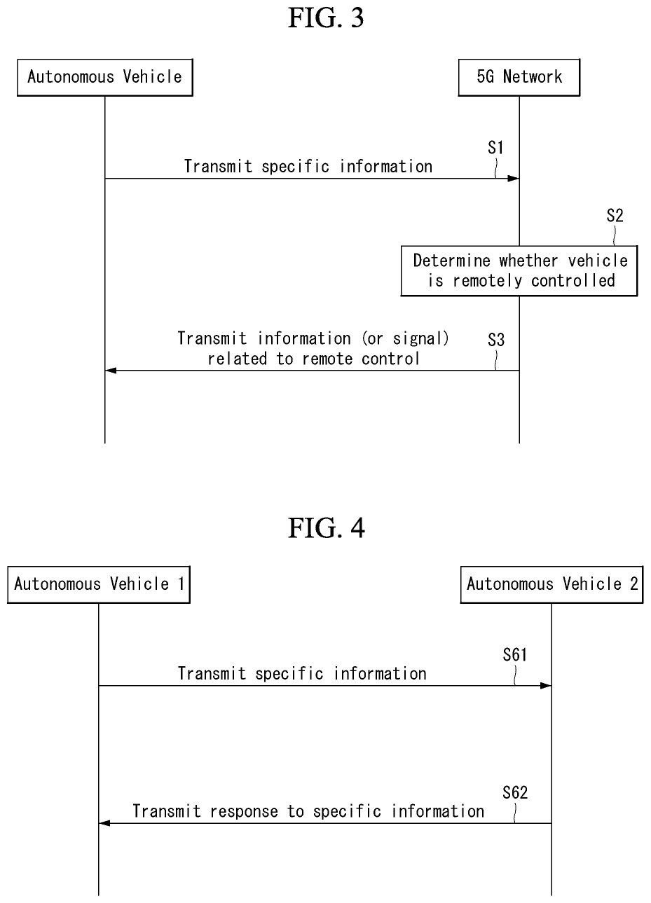

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

Driving

(1) Exterior of Vehicle

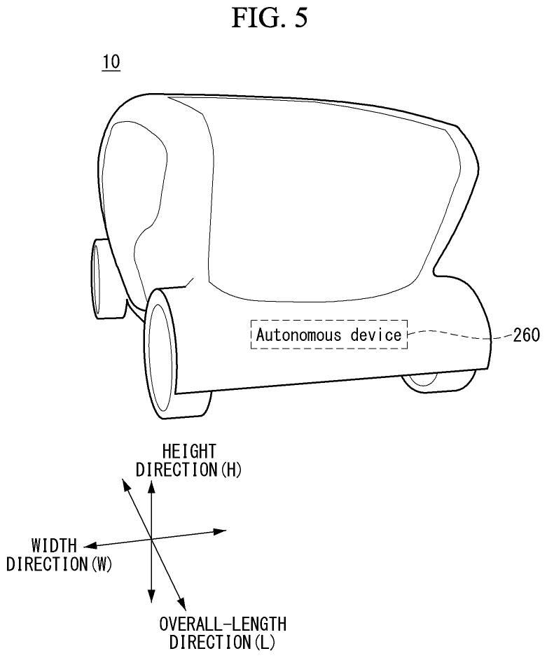

FIG. 5 is a diagram showing a vehicle according to an embodiment of the present invention.

Referring to FIG. 5, a vehicle 10 according to an embodiment of the present invention is defined as a transportation means travelling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

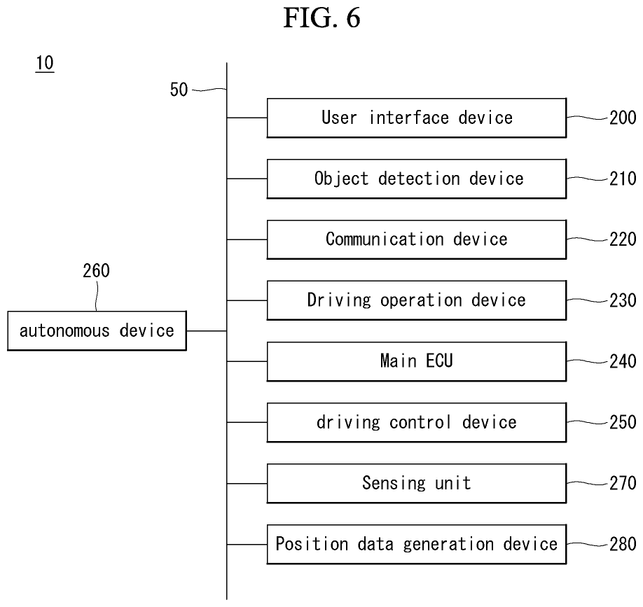

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Radio access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for travelling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

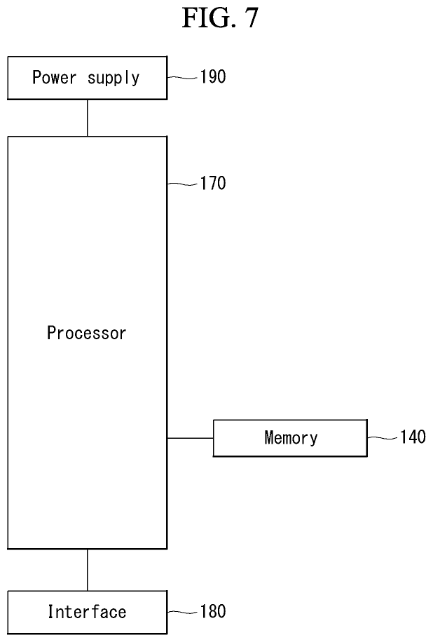

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

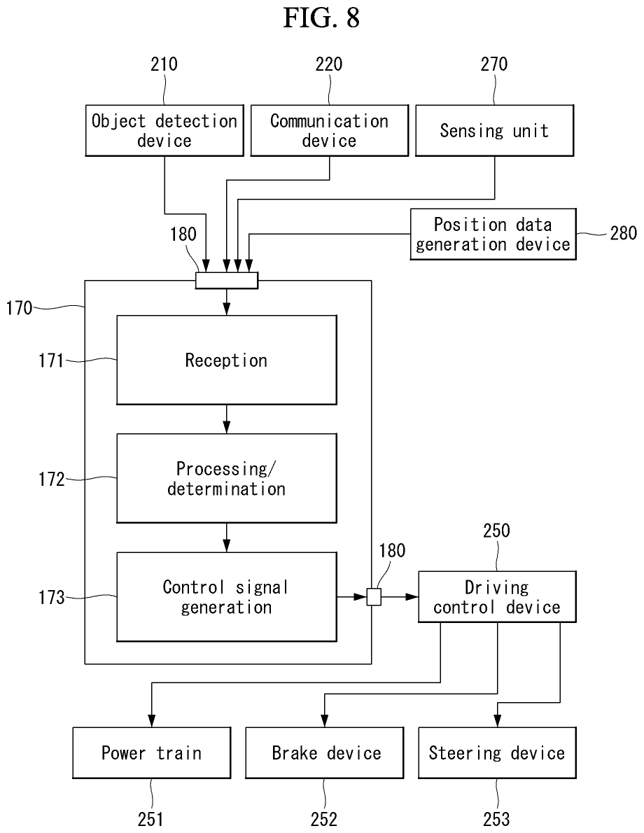

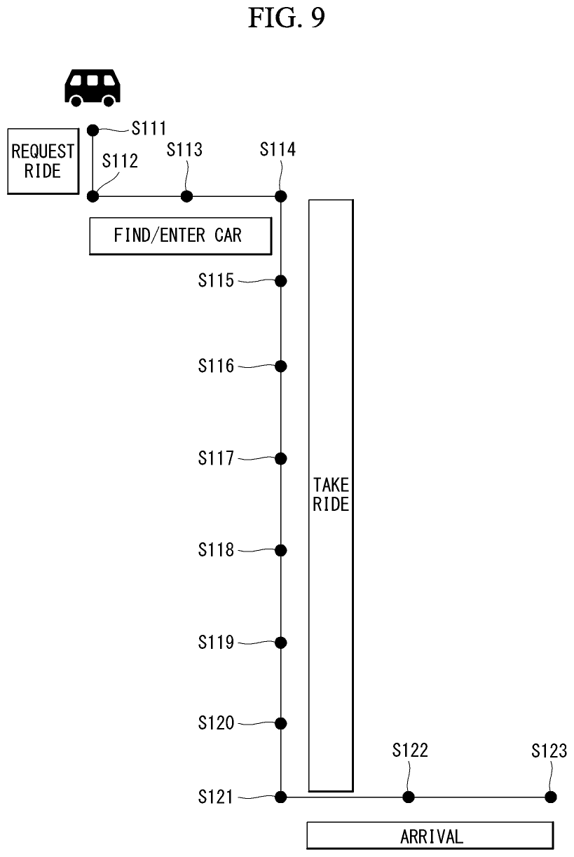

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of travelling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined travelling route. The horizon may refer to a point at which the vehicle can arrive after a predetermined time from the position at which the vehicle 10 is located along a predetermined travelling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers.

The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

(2) Autonomous Vehicle Usage Scenarios

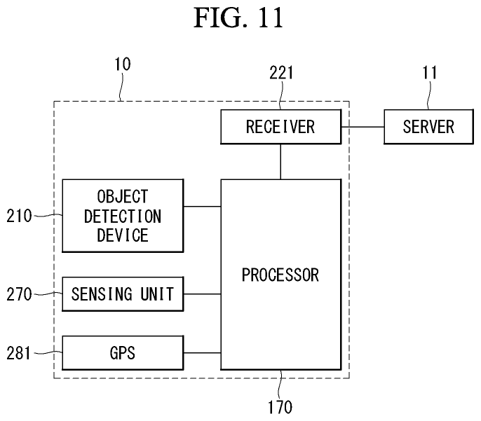

FIG. 11 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electric al signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

C-V2X

A wireless communication system is a multiple access system that shares an available system resource (e.g., bandwidth, transmission power, etc.) to support communication with multiple users. Examples of the multiple access system include a CDMA (code division multiple access) system, an FDMA (frequency division multiple access) system, a TDMA (time division multiple access) system, an OFDMA (orthogonal frequency division multiple access) system, an SC-FDMA (single carrier frequency division multiple access) system, an MC-FDMA (multi carrier frequency division multiple access) system and others.

A sidelink refers to a communication method where a direct link is set between UE (User Equipment), so that voice, data or the like is directly exchanged between UE without passing through a base station (BS). The sidelink is considered as one solution to alleviate a burden of the base station due to the rapidly increasing data traffic.

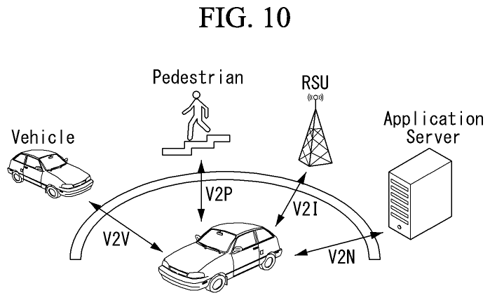

FIG. 10 illustrates an example of V2X communication to which the present disclosure is applicable.

The V2X (vehicle-to-everything) refers to a communication technology that exchanges information with other vehicles, pedestrians, and things in which infrastructures are built, through wired/wireless communication. The V2X may be classified into four types, namely, V2V (Vehicle-to-Vehicle) referring to communication between vehicles, V2I (Vehicle to Infrastructure) referring to communication between a vehicle and an eNB or RSU (Road Side Unit), V2P (Vehicle-to-Pedestrian) referring to communication between UE carried by a vehicle and an individual (pedestrian, bicyclist, vehicle driver or passenger), and V2N (vehicle-to-network).

The V2X communication may have the same meaning as the V2X sidelink or NR V2X or may have a broader meaning including the V2X sidelink or NR V2X.

The V2X communication may be provided via a PC5 interface and/or an Uu interface. In this case, specific network entities may be present in the wireless communication system for supporting the V2X communication to support communication between the vehicle and all the entities. For example, the network entity may be BS (eNB), an RSU (road side unit), UE, or an application server (e.g., traffic safety server), etc.

Furthermore, the UE performing the V2X communication may mean general handheld UE, vehicle UE (V-UE), pedestrian UE, a BS type (eNB type) of RSU, or an UE type of RSU, a robot having a communication module and the like.

The V2X communication may be performed directly between UE, or performed via the network entity (entities). The V2X operation mode may be classified according to the method of performing the V2X communication.

Meanwhile, as more communication devices require a larger communication capacity, there is a need for mobile broadband communication improved as compared to existing Radio Access Technology (RAT). Accordingly, a communication system considering service or UE that is sensitive to reliability and latency is under discussion. A next-generation radio access technology that considers improved mobile broadband communication, massive MTC, URLLC (Ultra-Reliable and Low Latency Communication), etc. may be referred to as new RAT (new radio access technology) or NR (new radio). In the NR, the V2X (vehicle-to-everything) communication may be supported.

The following technology may be used in various wireless communication systems, such as the CDMA (code division multiple access), the FDMA (frequency division multiple access), the TDMA (time division multiple access), the OFDMA (orthogonal frequency division multiple access) or the SC-FDMA (single carrier frequency division multiple access). The CDMA may be implemented with wireless technology such as an UTRA (universal terrestrial radio access) or CDMA2000. The TDMA may be implemented with wireless technology such as a GSM (global system for mobile communications)/a GPRS (general packet radio service)/EDGE (enhanced data rates for GSM evolution). The OFDMA may be implemented with wireless technology such as IEEE (institute of electrical and electronics engineers) 802.11 (Wi-Fi), IEEE 802.16 (WiMAX), IEEE 802-20, or E-UTRA (evolved UTRA). The IEEE 802.16m is evolution of IEEE 802.16e, and provides backward compatibility with the system based on the IEEE 802.16e. The UTRA is a part of an UMTS (universal mobile telecommunications system). 3GPP (3rd generation partnership project) LTE (long term evolution) is a part of E-UMTS (evolved UMTS) that uses E-UTRA (evolved-UMTS terrestrial radio access), employs the OFDMA in the downlink, and employs the SC-FDMA in the uplink. The LTE-A (advanced) is evolution of 3GPP LTE.

5G NR is a follow-up technology of LTE-A, and is a new clean-slate type of mobile communication system having characteristics such as high performance, low latency, and high availability. The 5G NR may utilize all available spectrum resources including a low frequency band less than 1 GHz, an intermediate frequency band from 1 GHz to 10 GHz, and a high frequency (millimeter wave) band of 24 GHz or more.

For the clarity of description, the LTE-A or the 5G NR is mainly described, but the technical scope of the present disclosure is not limited thereto.

The above-described 5G communication technology may be applied in combination with methods proposed in the present disclosure that will be described later, or may be supplemented to specify or clarify the technical features of methods proposed in the present disclosure.

FIG. 11 is a diagram showing an autonomous driving system according to an embodiment of the present disclosure.

Referring to FIG. 11, the autonomous driving system according to the embodiment of the present disclosure includes a vehicle 10 and a server 11.

The server 11 may determine an alignment section and transmit information on the alignment section to a receiver 221 of the vehicle 10. The alignment section may be determined based on the degree of traffic jam. When the average speed of all vehicles driving in any section is equal to or less than a critical speed, the corresponding section may be determined as the alignment section. In addition, particularly, the server 11 may determine the alignment section by artificial intelligence learning traffic volume, traffic lights, the number of lanes and the like.

As illustrated in FIG. 6, the vehicle 10 may include an object detection device 210, a sensing unit 270, a GPS 281, a receiver 221, and a processor 170. The processor 170 controls to form a cluster as the vehicle 10 enters the alignment section. The cluster refers to a state where at least some areas of a plurality of vehicles share one lane.

Hereinafter, various embodiments of the method of driving while forming the cluster in the autonomous driving system according to the present disclosure will be described.

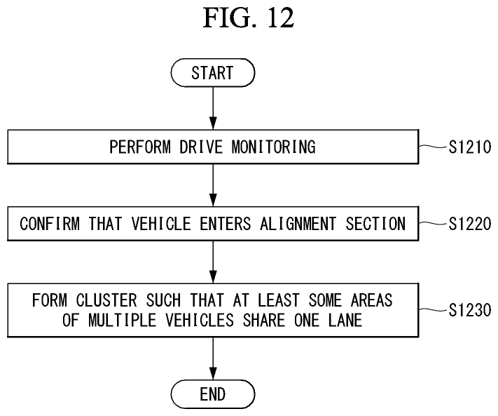

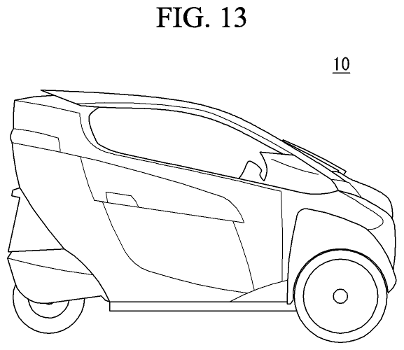

FIG. 12 is a flowchart showing a method for controlling a vehicle in an autonomous driving system according to an embodiment of the present disclosure.

Referring to FIG. 12, the method for controlling the vehicle in the autonomous driving system according to the embodiment of the present disclosure performs drive monitoring at a first step S1210. The step of drive monitoring includes a step of confirming the position information of a section in which a vehicle is currently driving.

At a second step S1220, it is confirmed that the vehicle enters the alignment section.

At a third step S1230, vehicles entering the alignment section form the cluster. The cluster is formed such that at least some areas of the plurality of vehicles share one lane. The sharing of the lane refers to a state where the vehicles are arranged side by side in a direction perpendicular to a travel direction in one lane. That is, the cluster means that (n+m) vehicles (n and m are natural numbers) are arranged side by side in the direction perpendicular to the travel direction over n lanes.

The autonomous driving according to the embodiment of the present disclosure can reduce the overall traffic volume occupying a road by forming the cluster with the plurality of vehicles.

In the embodiment of the present disclosure, the size of the vehicle is limited to less than a reference size to form the cluster. The reference size may be set within a range less than ⅔ of a lane width. As illustrated in FIG. 13, a one-seater or two-seater micro car may be a condition for forming the cluster.

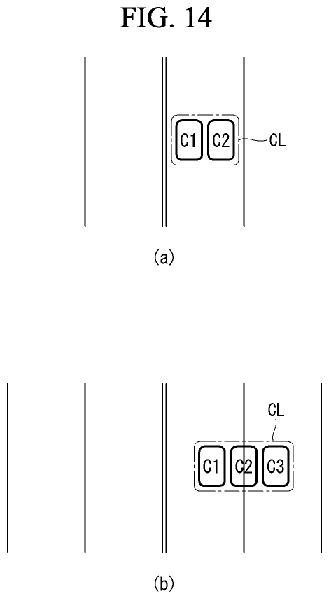

FIG. 14 includes diagrams showing an example of the cluster.

Referring to FIG. 14A, the cluster may be set such that two vehicles are arranged side by side in a direction perpendicular to a driving direction in one lane.

Referring to FIG. 14B, the cluster may be set such that three vehicles are arranged side by side in the direction perpendicular to the driving direction in two lanes.

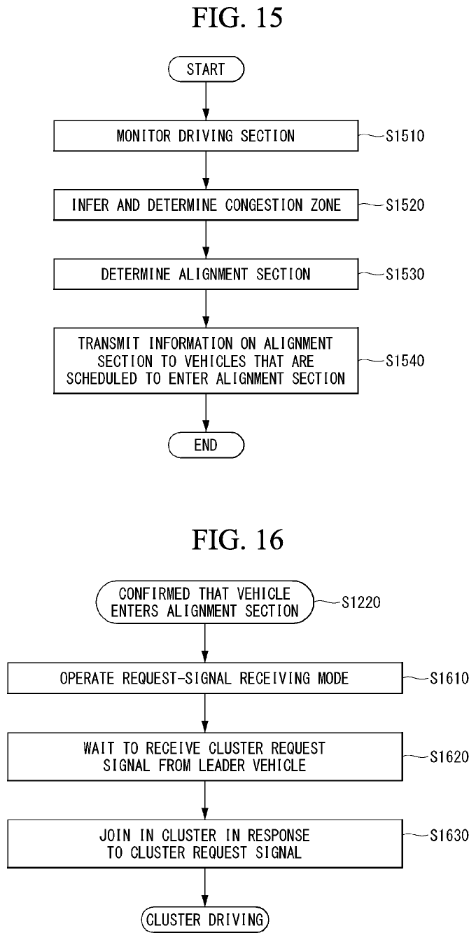

FIG. 15 is a diagram showing an embodiment of the method for determining the alignment section. The procedure shown in FIG. 15 may be performed in vehicles driving on a road, or may be performed in the server 11.

Referring to FIG. 15, in order to determine the alignment section, a driving section is monitored at a first step S1510. The step of monitoring the driving section refers to monitoring the traffic volume of the road.

At a second step S1520, a congestion zone is inferred and determined based on monitored information. In particular, in the embodiment of the present disclosure, a process of inferring and determining the congestion zone may include a process of learning based on accumulated traffic information.

At a third step S1530, the alignment section is determined based on the congestion zone. The alignment section may be determined based on the number of lanes, traffic lights and traffic signs in addition to the congestion zone.

At a fourth step S1540, information on the alignment section is transmitted to vehicles that are scheduled to enter the corresponding alignment section.

The vehicles constituting the cluster may be divided into a leader vehicle and a member vehicle. The leader vehicle may broadcast a request signal to call member vehicles, and the member vehicle may join in the cluster in response to the request signal of the leader vehicle. Such a process is as follows.

FIG. 16 is a flowchart illustrating an embodiment of a cluster forming process. FIG. 16 illustrates the process of joining in the cluster as the member vehicle.

Referring to FIG. 16, when it is confirmed that the vehicle enters the alignment section at step S1220, the vehicle enters a request-signal receiving mode at a first step S1610.

At a second step S1620, the vehicle operating the request-signal receiving mode waits to receive a cluster request signal from the leader vehicle.

At a third step S1630, the vehicle receiving the cluster request signal from the leader vehicle joins in the cluster in response to the cluster request signal.

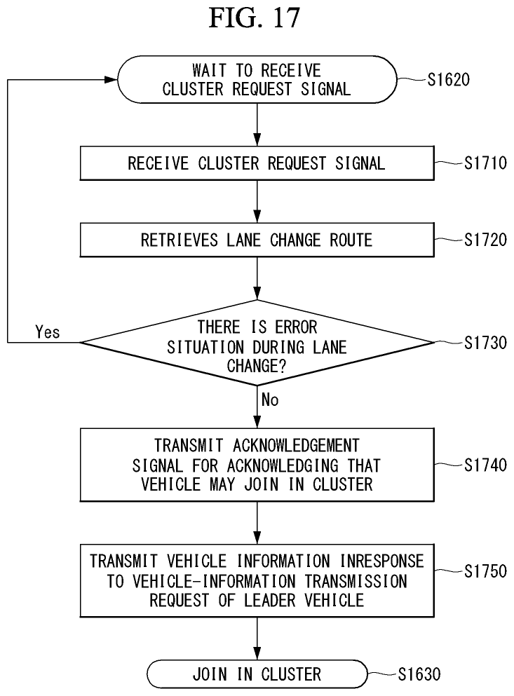

FIG. 17 is a flowchart showing a cluster joining process according to an embodiment of the present disclosure.

Referring to FIG. 17, the member vehicle waiting to receive a cluster request signal at step S1620 receives the cluster request signal at first step S1710.

At a second step S1720, the member vehicle receiving the cluster request signal retrieves a lane change route.

At a third step S1730, it is determined that there is an error situation during the lane change. For example, it is confirmed whether it is possible to change lanes or overtake the vehicle to join in the cluster formation.

At a fourth step S1740, the member vehicle confirming that there is no error situation during the lane change transmits an acknowledgement signal for acknowledging that the vehicle may join in the cluster. When it is confirmed that the member vehicle drives in the same direction as the leader vehicle at an intersection located within a predetermined distance, the member vehicle may transmit the acknowledgement signal. Furthermore, when it is confirmed that the size of a host vehicle is less than a reference size, the member vehicle may transmit the acknowledgement signal.

At a fifth step S1750, the member vehicle transmitting the acknowledgement signal transmits vehicle information in response to the vehicle-information transmission request of the leader vehicle. The vehicle information may include size information and driving information. The size information may include width information and length information of a vehicle body, and the driving information may include destination information and travelling route information.

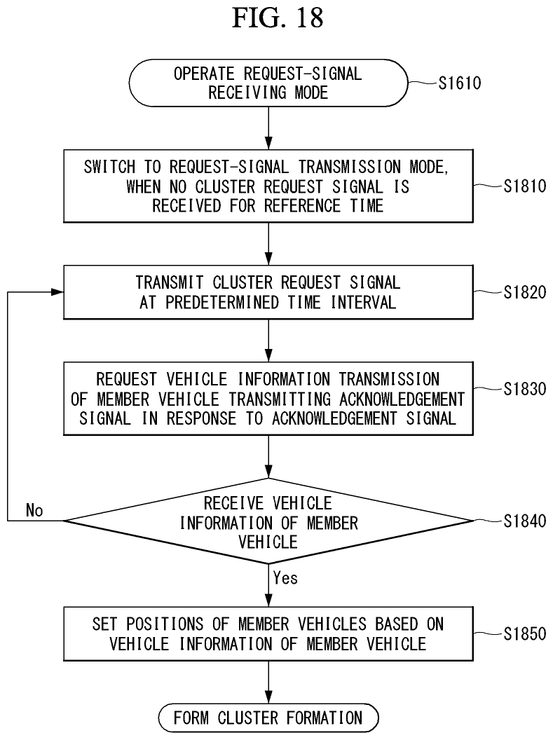

FIG. 18 is a flowchart illustrating a cluster forming process according to another embodiment. FIG. 18 illustrates a method where the leader vehicle calls the member vehicle. In FIG. 18, the step of operating the request-signal receiving mode may correspond to a procedure that is performed when it is confirmed that the vehicle enters the alignment section described with reference to FIG. 16.

Referring to FIG. 18, according to the request-signal receiving mode described in FIG. 16, the vehicle enters the standby state for receiving the cluster request signal at step S1610.

At a first step S1810, when it is confirmed that the cluster request signal is not received for a reference time, the vehicle enters a request-signal transmission mode. The request-signal transmission mode corresponds to a mode where there is no preceding leader vehicle in an adjacent state and a corresponding vehicle serves as the leader vehicle.

At a second step S1820, the leader vehicle that has switched to the request-signal transmission mode broadcasts the cluster request signal at predetermined time interval.

At a third step S1830, if the vehicle receives the acknowledgement signal from the member vehicle, the leader vehicle requests the vehicle information transmission of the member vehicle that transmits the corresponding acknowledgement signal in response to the acknowledgement signal.

At a fourth step S1840, it is confirmed that the leader vehicle receives the vehicle information of the member vehicle.

At a fifth step S1850, when it is confirmed that the leader vehicle receives the vehicle information of the member vehicle, the leader vehicle sets the positions of the member vehicles and transmits the positions to the member vehicles.

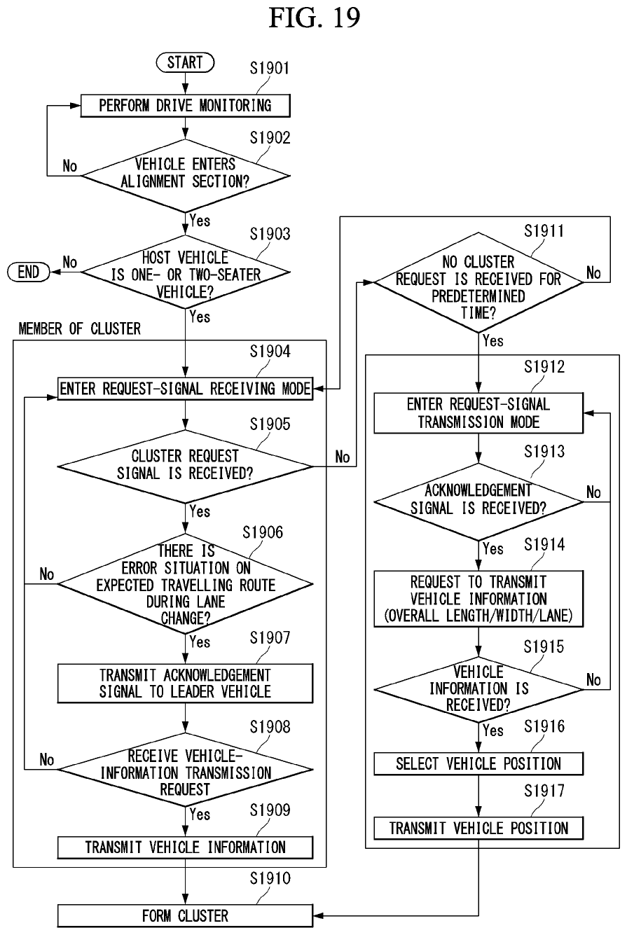

FIG. 19 is a flowchart showing a method for controlling a vehicle in an autonomous driving system according to an embodiment of the present disclosure. FIG. 19 shows the embodiment where the driving vehicle selects the role of the member vehicle or the leader vehicle to form the cluster, in combination with the above-described embodiments.

Referring to FIG. 19, the vehicle that is driving autonomously at a first step S1901 performs drive monitoring. The drive monitoring includes a step of acquiring position information.

At a second step S1902, it is confirmed whether the vehicle enters the alignment section. Based on the alignment section information received from an external server, it may be confirmed that the vehicle enters the alignment section.

At a third step S1903, the vehicle may confirm the vehicle size of the host vehicle. For example, the vehicle determines whether the size of the host vehicle corresponds to a reference size.

At a fourth step S1904, the vehicle having a size less than the reference size enters a request-signal receiving mode, so that the vehicle waits to receive a request signal from the leader vehicle.

At a fifth step S1905, it is confirmed whether the vehicle receives the cluster request signal.

At a sixth step S1906, the vehicle that has received the cluster request signal retrieves an expected travelling route for changing lanes, and confirms that there is an error situation on the expected travelling route.

At a seventh step S1907, when it is confirmed that there is no error situation on the expected travelling route, the vehicle transmits the acknowledgement signal to the leader vehicle.

At an eighth step S1908, the member vehicle transmitting the acknowledgement signal confirms that the vehicle-information transmission request is received from the leader vehicle.

At a ninth step S1909 and at a tenth step S1910, the member vehicle confirming that the vehicle-information transmission request is received transmits the vehicle information of the host vehicle to the leader vehicle and joins in the cluster formation.

When the cluster request signal is not received, the vehicle which waits to receive the cluster request signal at the above-described fifth step S1905 counts a time when no cluster request signal is received at an eleventh step S1911.

Subsequently, at a twelfth step S1912, when it is confirmed that no cluster request signal is received for the reference time, the vehicle enters the request-signal transmission mode.

At a thirteenth step S1913 and at a fourteenth step S1914, in response to the acknowledgement signal from the member vehicle, the vehicle information is requested to be transmitted to the corresponding member vehicle.

At fifteenth to seventeenth steps S1915, S1916 and S1917, based on the vehicle information transmitted to the member vehicle, the relative position of the member vehicles in the cluster is selected to determine the cluster formation, and the cluster formation is transmitted to the member vehicle.

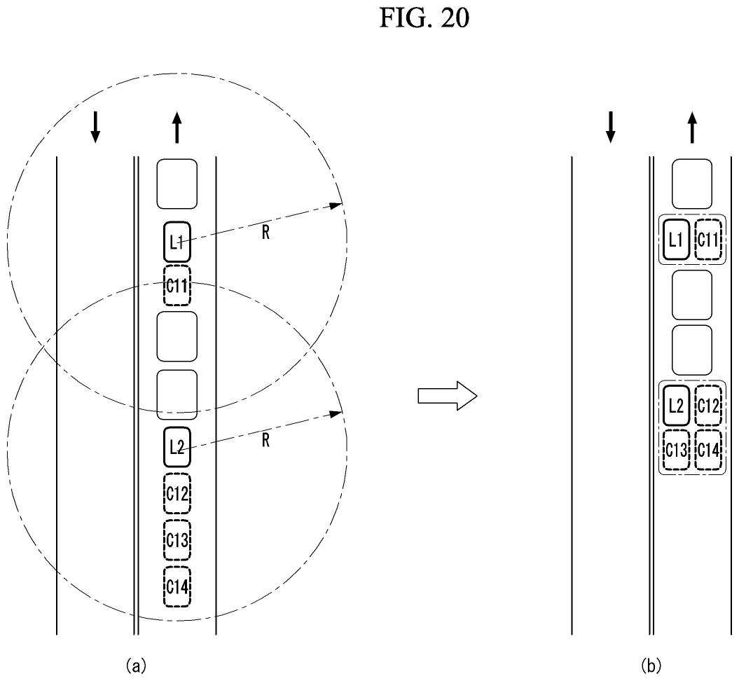

FIG. 20 includes diagrams illustrating a cluster forming process in a single lane.

Referring to FIG. 20A, a first leader vehicle L1 and a second leader vehicle L2 corresponds to vehicles that do not receive the cluster request signal, as described in the eleventh step S1911 of FIG. 19. The first leader vehicle L1 and the second leader vehicle L2 transmit the cluster request signal to the vehicles within a predetermined radius R.

Referring to FIG. 20B, a first member vehicle C11 located within the predetermined radius R from the first leader vehicle L1 forms a first cluster CL1, in response to the cluster request signal of the first leader vehicle L1. Furthermore, second to fourth member vehicles C12 to C14 located within the predetermined radius R from the second leader vehicle L2 form a second cluster CL2, in response to the cluster request signal of the second leader vehicle L2.

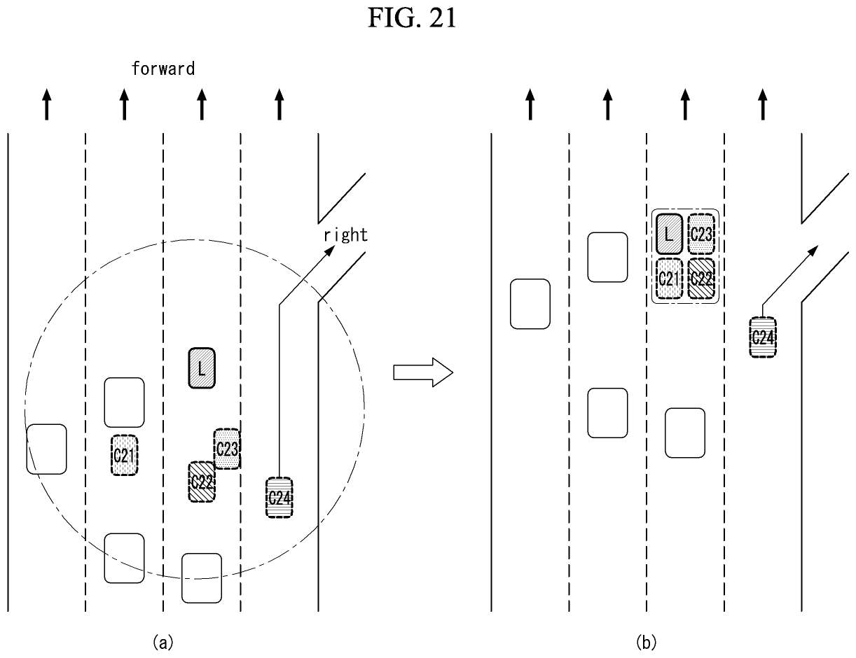

FIG. 21 includes diagrams illustrating a cluster forming process in a plurality of lanes.

Referring to FIG. 21A, the leader vehicle L corresponds to the vehicle that does not receive the cluster request signal as described at the eleventh step S1911 of FIG. 19. The leader vehicle L transmits the cluster request signal to vehicles within the predetermined radius R, namely, first to fourth vehicles C21 to C24. The cluster request signal may include the travelling route information of the leader vehicle L. In FIG. 21, the travelling route of the leader vehicle L includes information that it travels forwards. The first to fourth vehicles C21 to C24 each having a size less than a reference size may determine whether the acknowledgement signal is transmitted based on the travelling route information of the leader vehicle L. For example, as the first to third vehicles C21 to C23 are scheduled to travel forwards, the acknowledgement signal may be transmitted in response to the cluster request signal from the leader vehicle L. Since the fourth vehicle C24 is scheduled to turn right, it may not respond to the cluster request signal from the leader vehicle L.

Consequently, as shown in FIG. 19B, the leader vehicle L may be driven while forming the cluster CL with the first to third vehicles C21 to C23.

In FIG. 21, the relative position of the first to third member vehicles C1 to C23 forming the cluster may be set based on driving information. The driving information may include a travelling route along which the vehicles are to be travelled. Based on the driving information, it is possible to determine a point at which the member vehicles deviate from the cluster.

The leader vehicle L may form the cluster formation based on the travel route of the member vehicles C1 to C23 at the cluster deviating point. For example, at a specific intersection where the vehicles are to reach during the cluster driving, if the leader vehicle L is scheduled to pass straight through the intersection and the first vehicle C21 is scheduled to turn left at the intersection to deviate from the cluster, the first vehicle C21 may be disposed on the left in the driving direction. Similarly, if the second vehicle C22 is scheduled to turn left at the intersection to deviate from the cluster, the second vehicle C22 may be disposed on the right in the driving direction.

Furthermore, if the vehicles are arranged in two or more rows in the cluster formation, a vehicle travelling the longest distance with the leader vehicle may be arranged in the same row as the leader vehicle L. That is, in FIG. 21, the third vehicle C23 corresponds to the vehicle travelling the longest distance with the leader vehicle L.

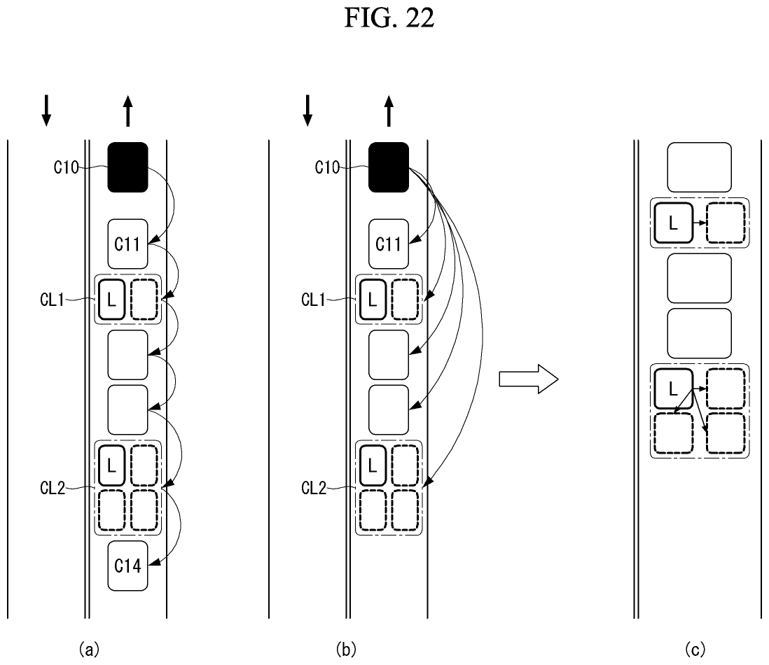

FIG. 22 includes diagrams illustrating embodiments of a communication method in cluster driving.

Referring to FIG. 22A, during the cluster driving, a message from a preceding vehicle C10 may be transmitted in a multi-hop manner That is, the preceding vehicle C10 transmits the message to a following vehicle C11 that is closest to the host vehicle, and the following vehicle that has received the message transmits the message to the cluster CL1. The cluster CL1 transmits the message the following vehicle that is closest to the corresponding cluster. In this way, the message from the preceding vehicle C10 may be sequentially transmitted through adjacent following vehicles to a final vehicle.

Referring to FIG. 22B, during the cluster driving, the message from the preceding vehicle C10 may be transmitted in a broadcasting manner. That is, the preceding vehicle C10 may simultaneously transmit the message to all vehicles and clusters CL1 and CL2 adjacent to the host vehicle.

In order to transmit the message to all the vehicles belonging to the clusters CL1 and CL2, the leader vehicle L of the clusters CL1 and CL2 primarily receives the message. As illustrated in FIG. 21C, the leader vehicle L transmits the corresponding message to member vehicles belonging to the cluster.

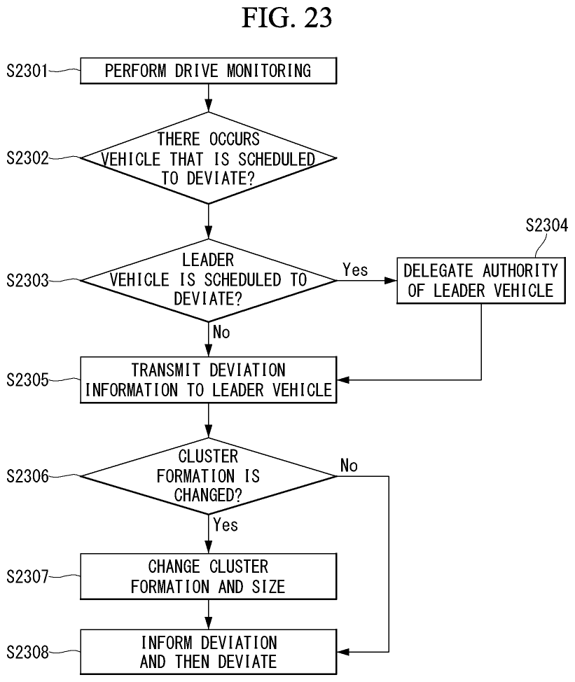

FIG. 23 is a flowchart illustrating a deviation process of a member vehicle in the cluster driving. FIG. 23 is the flowchart illustrating the deviation process of the member vehicle on the basis of the travelling route.

Referring to FIG. 23, drive monitoring is performed at a first step S2301. The process of performing the drive monitoring may include a step of acquiring the position information and the obstacle information.

At a second step S2302, it is confirmed whether there is a vehicle that is scheduled to deviate from the travelling route.

At a third step S2303 and at a fourth step S2304, if the vehicle that is scheduled to deviate from the travelling route is the leader vehicle, the leader vehicle delegates leader authority to the following vehicle.

At a fifth step S2305, the member vehicle that is scheduled to deviate from the travelling route transmits the deviation information to the leader vehicle. The deviation information may include vehicle ID, deviating position information, deviating direction information and the like.

At a sixth step S2306, the leader vehicle determines whether it is necessary to change the cluster formation on the basis of the deviation information.

At a seventh step S2307, when it is necessary to change the cluster formation, the leader vehicle transmits position information in a new cluster formation to each of the member vehicles. On the basis of the position information, the member vehicles may be aligned in the new cluster formation. The new cluster formation is formed to facilitate the deviation of the member vehicle that is about to deviate from the travelling route.

At an eighth step S2308, the deviating member vehicle informs the leader vehicle of its deviation and then deviates from the travelling route.

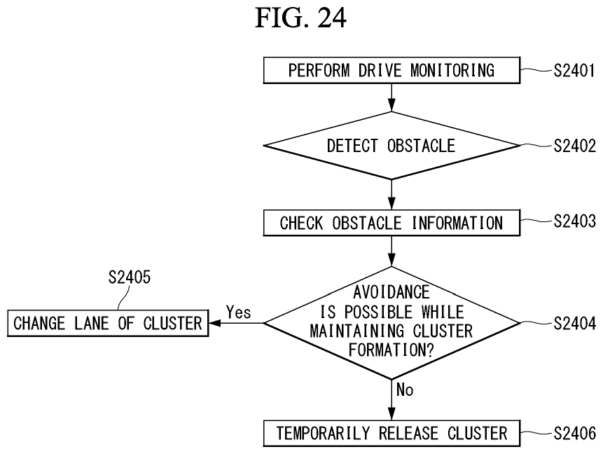

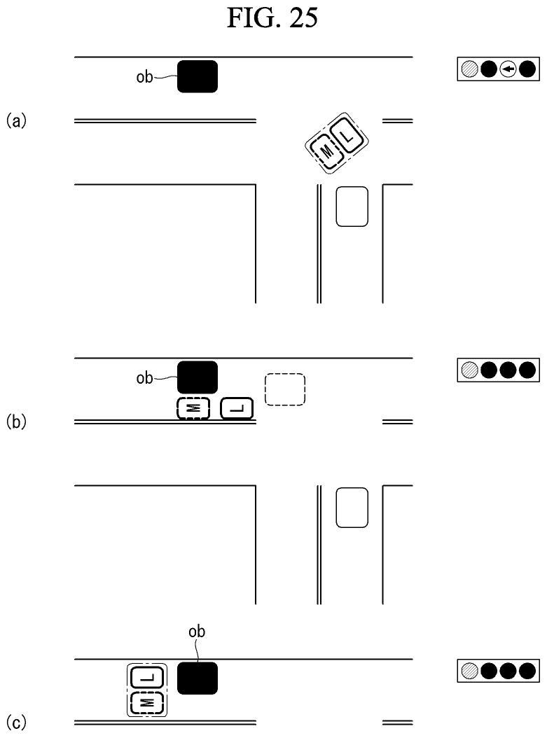

FIG. 24 is a flowchart illustrating a process where a member vehicle deviates from a cluster according to another embodiment, and FIG. 25 includes diagrams illustrating temporary release of a cluster formation to avoid an obstacle.

Referring to FIGS. 24 and 25, at a first step S2401, a driving state is monitored.

At a second step S2402, vehicles of the cluster CL may detect the obstacle on a road. The obstacle refers to an object that obstructs the travelling route of at least any one of the vehicles in the cluster CL. For example, as illustrated in FIG. 25A, when a first vehicle ob is stopped near a sidewalk, the cluster CL turning left at the intersection may determine the first vehicle ob as the obstacle.

When the member vehicle M detects the obstacle, the member vehicle M transmits the detected obstacle information to the leader vehicle L.

At a third step S2403, the leader vehicle L checks the obstacle information. When the leader vehicle L detects the obstacle, the leader vehicle L determines the size and position of the obstacle on the basis of the acquired obstacle information. Alternatively, the leader vehicle L may confirm the size and position of the obstacle on the basis of the obstacle information transmitted from the member vehicle M.

At a fourth step S2404, in order to avoid the obstacle, the leader vehicle L determines whether the entire lane change is possible while maintaining the formation of the cluster CL. The leader vehicle L determines a route to avoid the obstacle on the basis of the obstacle information from the member vehicle M or the obstacle information acquired by the host vehicle.

At a fifth step S2405, if the entire lane change of the cluster CL is possible to avoid the obstacle, the cluster CL performs the lane change while maintaining the formation that adopts during travelling.

Meanwhile, if the entire lane change of the cluster CL is impossible to avoid the obstacle, at a sixth step S2406, the formation of the cluster CL is temporarily released. For example, as illustrated in FIG. 25B, the leader vehicle L and the member vehicle M may travel longitudinally with respect to the travelling direction. After avoiding the obstacle, as illustrated in FIG. 25C, the cluster is formed again.

When it is impossible to avoid the obstacle even if the cluster CL is temporarily released, the cluster CL may be released.

The above-described present disclosure may be embodied as a computer readable code on a medium on which a program is recorded. The computer readable medium includes all kinds of recording devices in which data that can be read by the computer system is stored. Examples of the computer readable medium include Hard Disk Drives (HDD), Solid State Disks (SSD), Silicon Disk Drives (SDD), ROMs, RAMs, CD-ROMs, magnetic tapes, floppy disks, optical data storages and others. Furthermore, the computer readable medium may be embodied in the form of a carrier wave (e.g. transmission via the Internet). Therefore, the above embodiments are to be construed in all aspects as illustrative and not restrictive. The scope of the present disclosure should be determined by reasonable analysis of the claims and all changes within an equivalent range of the present disclosure is included in the scope of the present disclosure.

Although the present disclosure was described above with reference to embodiments, the embodiments are only examples and do not limit the present disclosure, and those skilled in the art would know that the present disclosure may be changed and modified in various ways not exemplified above without departing from the scope of the present disclosure. For example, the components described in detail in the embodiments of the present disclosure may be modified. Further, differences relating to the changes and modifications should be construed as being included in the scope of the present disclosure which is determined by claims.

What is claimed is:

1. A method for controlling a vehicle in an autonomous driving system, comprising:
monitoring driving information;
acquiring a position information from the driving information; and
forming a cluster such that at least some areas of a plurality of vehicles share one lane, based on confirmation that the position information corresponds to the alignment section where a traffic jam occurs.

2. The method of claim 1, wherein the confirming whether the position information corresponds to the alignment section comprises:
acquiring traffic information by a server;
determining the alignment section by learning the traffic information by the server; and
transmitting information on the alignment section to vehicles that are scheduled to enter the alignment section.

3. The method of claim 1, wherein the forming of the cluster comprises:
setting a positional relationship between the vehicles such that (n+m) vehicles (n and m are natural numbers) are arranged side by side in a direction perpendicular to a travel direction over n lanes.

4. The method of claim 1, wherein the forming of the cluster comprises:
receiving a cluster request signal from a leader vehicle based on confirmation that the vehicle enters the alignment section; and
causing the vehicle to join in the cluster, in response to the cluster request signal.

5. The method of claim 4, wherein the forming of the cluster further comprises:
retrieving a lane change route, in response to the cluster request signal; and
transmitting an acknowledgement signal for acknowledging that the vehicle may join in the cluster to the leader vehicle based on confirmation that there is no error situation for entering the lane change route.

6. The method of claim 5, wherein the transmitting of the acknowledgement signal is performed based on confirmation that a size of a host vehicle is less than a reference size, and
the reference size is less than ⅔ of a lane width.

7. The method of claim 5, wherein the transmitting of the acknowledgement signal is performed based on confirmation that the vehicle is driving in the same direction as the leader vehicle at an intersection located within a predetermined distance.

8. The method of claim 4, wherein the forming of the cluster further comprises:
receiving a vehicle-information transmission request from the leader vehicle that has received the response signal; and
transmitting the vehicle information including information on the size of the host vehicle to the leader vehicle, in response to the vehicle-information transmission request.

9. The method of claim 8, wherein the forming of the cluster further comprises:
determining a position of a member vehicle in the cluster to which the leader vehicle transmits the acknowledgement signal, based on the vehicle information.

10. The method of claim 9, wherein the determining of the position of the member vehicle is set such that two vehicles are arranged side by side in a direction perpendicular to a driving direction in one lane, based on the size information.

11. The method of claim 9, wherein the determining of the position of the member vehicle is set such that three vehicles are arranged side by side in a direction perpendicular to a driving direction in two lanes, based on the size information.

12. The method of claim 8, wherein the vehicle information further comprises information on a travelling route, and
the determining of the position of the member vehicle is performed based on the information on the travelling route, and the member vehicle is disposed in a direction away from a row of the cluster.

13. The method of claim 12, wherein the determining of the position of the member vehicle further comprises setting to dispose the member vehicle travelling the longest section with the leader vehicle in the same row as the leader vehicle, when the cluster is formed of two or more rows.

14. The method of claim 4, further comprising:
broadcasting the cluster request signal such that the host vehicle serves as the leader vehicle, when it is confirmed that the cluster request signal is not received for a reference time.

15. The method of claim 14, wherein the forming of the cluster further comprises:
identifying a vehicle that transmits the acknowledgement signal informing that the vehicle is to join in the cluster, in response to the cluster request signal;
requesting the vehicle information including information on the vehicle size from the member vehicle transmitting the acknowledgement signal, in response to the acknowledgement signal; and
determining positions of member vehicles in the cluster, based on the vehicle information.

16. The method of claim 1, further comprising:
driving while maintaining the cluster;
detecting an obstacle by at least one vehicle in the cluster; and
avoiding the obstacle while maintaining the cluster, based on confirmation that there is a lane to avoid the obstacle while maintaining the cluster.

17. The method of claim 16, further comprising:
temporarily releasing the cluster to avoid the obstacle, based on confirmation that there is no lane to avoid the obstacle while maintaining the cluster.

18. The method of claim 1, wherein the forming of the cluster further comprises:
dividing the vehicles constituting the cluster into the leader vehicle and the member vehicle;
causing the leader vehicle to receive a message from a vehicle other than the cluster;
causing the leader vehicle to transmit the message to the member vehicle; and
causing the member vehicle to change driving based on the message.
